(19) United States
(12) Patent Application Publication
(10) Pub. No.: US 2025/0156841 A1
(43) Pub. Date: May 15, 2025

(54) GENERATING UNIQUE AND SECURE GIFT CARDS

(71) Applicant: Target Brands, Inc., Minneapolis, MN (US)

(72) Inventors: Todd A. Hagen, Shakopee, MN (US); Andrew Wipf, Minneapolis, MN (US); Nicholas Lojewski, Minneapolis, MN (US); Donnie Tolbert, Carver, MN (US); Christopher Brakob, Minneapolis, MN (US)

(21) Appl. No.: 18/941,242

(22) Filed: Nov. 8, 2024

Related U.S. Application Data
(60) Provisional application No. 63/598,980, filed on Nov. 15, 2023.

(51) Int. Cl. G06Q 20/34; G06Q 20/20; G06Q 20/38; H04L 9/08

(52) U.S. Cl. CPC G06Q 20/342; G06Q 20/204; G06Q 20/3829; H04L 9/0825

(57) ABSTRACT

The disclosed system for performing a gift card purchase and activation in a retail environment can include a card retention apparatus having a unidirectional card removal component and a gift card, a card identifier and access code system to generate and assign unique identifying information to the card, and a printing device to print at least a portion of the unique information onto a surface of the card. A point of sale (POS) terminal can: identify the card for purchase, transmit, to the system, a request for the card's unique information, the request including a public encryption key, receive, in response to the system generating and encrypting the unique information using the public key, the encrypted information for the card, decrypt, using an associated private key, the encrypted information, and generate instructions for applying, via the printing device, the at least portion of the unique information onto the card's surface.

### INCORPORATION BY REFERENCE

This application claims the benefit of priority of U.S. Provisional Patent Application No. 63/598,980, filed Nov. 15, 2023, the entirety of which is incorporated herein.

### TECHNICAL FIELD

This disclosure generally describes devices, systems, apparatuses, and methods related to generating and applying unique and secure identifying information on physical gift cards at a time of gift card purchase at a checkout process in a retail environment, such as a store.

### BACKGROUND

Physical gift cards have often been made of a plastic material and have included a pre-generated unique card number that is used to identify the gift card and to redeem the stored value that is associated with the card. Such pre-generated unique card numbers can be generated and printed on gift cards prior to their placement on a shelf or other retail display, and prior to the gift card being purchased during a retail checkout process.

To provide added security, gift cards have often been pre-generated to include a PIN or other validating identifier that is paired with the unique gift card number and used to validate purchases using the gift card. For example, the gift card can be printed or otherwise generated with the card number and the PIN, and then put on a shelf in a retail environment, such as a store. When a retail customer purchases the gift card, the card number can be scanned, the purchase of the gift card can be verified, and then the gift card can be activated for redemption by presenting the card number in combination with the PIN. Sometimes, the PIN can be physically covered on the card with a protective film or other tamper-proof material that can prevent the PIN from being viewed unless the film or other tamper-proof material is at least partially removed. To reveal or otherwise view the PIN, a user may scratch off the film or other tamper-proof material.

Retail environments selling physical gift cards have been configured so that shoppers can select the gift card off the shelf and bring the gift card to a checkout terminal/station/counter/lane for purchase. When the gift card is purchased, one or more barcodes on the gift card can be scanned to identify the type of item being purchased (e.g., a gift card) as well as to identify the unique gift card number, and once payment is received in the amount of the gift card, the gift card can be activated. Once activated, the card can be used for making purchases with the card number and the PIN (e.g., a user receiving the gift card can scratch the film off of the card to reveal the PIN, then provide the PIN and the card number to a purchasing system to use a balance on the card for making a user-desired purchase).

### SUMMARY

The disclosure generally describes devices, systems, apparatuses, and methods related to generating and applying unique and secure identifying information on physical gift cards at or around a time of gift card purchase completion during a checkout process in a retail environment, such as a store. The physical gift cards can be placed on shelves or other retail stands for purchase without some or all of the unique identifying information and then, once the payment for the gift card has been received and verified, remaining portions of the unique identifying information can be generated and applied to the physical gift card. For example, after the payment for a gift card has been received, unique identifying information for the gift card can be generated (e.g., by a point of sale (POS) terminal, by a secure server system, and/or combinations thereof) and provided to a printing apparatus that is configured to receive the gift card and to print the unique identifying information on the card. The unique identifying information can include a card number. Additionally or alternatively, the unique identifying information can include a PIN number that can be associated with the purchased physical gift card. Applying the unique identifying information can include printing, affixing, or otherwise applying the unique identifying information on the physical gift card so that the gift card physically retains the unique identifying information. For example, printing the unique identifying information on the physical gift card can include providing the gift card to a printing device at a checkout terminal, where the printing device may receive instructions for printing the unique identifying information onto the gift card. The instructions can be generated by a point-of-sale (POS) terminal at the checkout terminal and/or a computer system. The instructions can be generated using encryption and decryption techniques to ensure that the unique identifying information for the purchased physical gift card may not be compromised.

More particularly, the disclosed technology provides a physical implementation for applying information on physical gift cards when they are purchased at checkout to avoid one or more types of gift card scams. Traditionally, a gift card can include a PIN that is covered with a protective film. A user may scratch off the protective film to view the PIN, which allows the user to make purchases with the gift card as a form of payment. Some malicious users have begun taking gift cards off the shelves before the gift cards are purchased and activated, and going to an offsite location where the malicious users remove the protective films, recording the PINs in association with the gift card numbers (or other combinations of unique identifying information that is pre-generated on the gift cards) into a system, reapplying the protective films, and then put the gift cards back on the shelves in the retail store. The intention of this scheme is to make the protective film or other tamper-proof material that has been reapplied to the cards appear authentic and original so that other, legitimate users within the store proceed to purchase the cards using the processes described above. While these recorded and compromised gift cards are on the shelves, the malicious users are polling online gift card systems using the recorded gift card number and PIN numbers (or other unique identifiers) until they are purchased and activated by the legitimate users, at which point the online gift card systems return a positive response to the polling queries by the malicious users. Once a positive response is received, the malicious users transfer and/or use the stored value associated with the gift cards to another account-effectively draining the stored value associated with the gifts cards without the knowledge of the legitimate user. Then, the purchasing users (and/or other users receiving the gift cards) cannot utilize the gift cards because the bad actors who scratched off the protective films and recorded the PINs have already drained the funds from the now-activated gift cards using the previously-recorded unique identifying information (e.g., combination of gift card numbers and PINs).

To address this and similar concerns, the disclosed innovation can additionally and/or alternatively include unidirectional gift card removal features that can be configured to provide customers with clear indications once gift cards have been removed from shelves, and/or can prohibit reinsertion of the gift cards on shelves after they have been removed. For example, gift cards can be provided with at least two parts that are designed to be separated from each other in order for the gift cards to be purchased and used. A first part of the gift card, such as a top of the gift card, can be secured within a locked retention apparatus (e.g., locked rack, wire, shelf, hanging structure) that is only able to be unlocked and for the first part of the gift card to be removed by an authorized retail employee. The second part can be configured to serve as the gift card itself, including none, some, or all of the unique identifying information already included on the gift card, and can be removably affixed to the first part, such as through a perforation between the first and the second part of the gift card. For example, displays in the retail environment can be configured so that a user may tear a second part of the gift card off of and from the first part of the gift card, which is retained in the display, in order to purchase the gift card, to which the generated unique identifying information can be applied, as described throughout this document. The gift card may not be returned to the display once torn off. The gift card can then be presented for purchase at the checkout terminal, which can include a printer. The printer can be configured to print a PIN onto the gift card once the gift card is scanned and purchased during checkout. The gift card may not have a PIN at a time that it is on the display at the shelf. Sometimes, the gift card may not have a unique card number at the time it is on the display at the shelf, but can be assigned such number at time of purchase during checkout. Sometimes, the gift card may have neither unique card number nor PIN at the time it is on the display at the shelf.

As an illustrative example, a user can tear a physical gift card from a locked display at a shelf and bring the gift card to a checkout terminal/counter for purchase. Once an employee at the checkout terminal rings up the gift card and the user pays for the gift card, the employee can feed the gift card into a printing device, which can output the gift card with a PIN printed on one of its surfaces. A POS terminal and/or computer system in communication with the printing device can create an association between the PIN and the particular gift card. The association can be made at time of purchase, checkout, and/or activation, where such an association does not exist when the gift card is initially created, attached to the display at the shelf, or otherwise any time before the gift card purchase. The POS terminal and/or the computer system can encrypt information associated with the particular gift card, such as generated instructions for printing the PIN onto the card that are transmitted to the printing device.

One or more embodiments described herein can include system for performing a gift card purchase and activation in a retail environment, the system including: a card retention apparatus that can include a unidirectional card removal component and a gift card, the gift card being removable from the card retention apparatus using the unidirectional card removal component, a point of sale (POS) terminal that can be configured to process a purchase and activation of the gift card that is removed from the card retention apparatus, a card identifier and access code system in network communication with the POS terminal and that can be configured to generate and assign unique identifying information to the gift card in response to the purchase and activation of the gift card at the POS terminal, and a printing device in network communication with the POS terminal and that can be configured to execute instructions received from the POS terminal to print at least a portion of the unique identifying information onto a surface of the gift card. The POS terminal can be configured to perform operations that include: scanning, using a scanning device of the POS terminal, a barcode of the gift card to identify the gift card, transmitting, to the card identifier and access code system, a request for the unique identifying information for the gift card, the request including a public encryption key associated with the identified gift card, receiving, from the card identifier and access code system and in response to the card identifier and access code system (i) generating the unique identifying information for the gift card and (ii) encrypting the unique identifying information using the public key, the encrypted unique identifying information for the gift card, decrypting, using a private key associated with the identified gift card, the encrypted unique identifying information, generating instructions for applying the at least portion of the unique identifying information onto the surface of the gift card, and returning, to the printing device, the instructions for execution.

In some implementations, the embodiments described herein can optionally include one or more of the following features. For example, the printing device can be configured to receive the gift card. In response to receiving payment, at the POS terminal, for the purchase and activation of the gift card, the POS terminal can be configured to perform the operation including transmitting, to the card identifier and access code system, a request for the unique identifying information for the gift card. The unique identifying information can be a card number associated with the identified gift card. The unique identifying information can be a PIN associated with the identified gift card. The unique identifying information can include a card number and a PIN associated with the identified gift card. The POS terminal can include an encryption mechanism, the encryption mechanism being configured to maintain the public key and the private key associated with the gift card.

The system can also include a card redemption system that can be configured to redeem and check balances associated with a group of gift cards in the retail environment. The instructions can include applying the unique identifying information onto a back surface of the gift card. The instructions can include a group of application steps, each of the group of application steps including applying a subset of values in the unique identifying information onto the surface of the gift card. The instructions can include (i) applying at least one false card identifying information onto a test document and (ii) applying the unique identifying information onto the surface of the gift card. The instructions can include applying each character of the unique identifying information individually. The instructions can include applying each character of the unique identifying information in a randomized order.

One or more embodiments described herein can include a method for performing a gift card purchase and activation in a retail environment, the method including: identifying, by a POS terminal in the retail environment, a gift card for purchase and activation, receiving, by the POS terminal, a payment for the purchase and activation of the identified gift card, transmitting, by the POS terminal to a card identifier and access code system, a request for unique identifying information for the gift card in response to processing the payment, the request including a public encryption key associated with the identified gift card, receiving, by the POS terminal from the card identifier and access code system and in response to the card identifier and access code system (i) generating the unique identifying information for the gift card and (ii) encrypting the unique identifying information using the public key, the encrypted unique identifying information for the gift card, decrypting, by the POS terminal using a private key associated with the identified gift card, the encrypted unique identifying information, generating, by the POS terminal, instructions for applying the at least portion of the unique identifying information onto a surface of the gift card, and returning, by the POS terminal to a printing device, the instructions for execution.

The method can optionally include one or more of the abovementioned features and/or following features. For example, identifying a gift card for purchase and activation can include scanning, using a scanning device of the POS terminal, a barcode or SKU of the gift card.

One or more embodiments described herein can include an apparatus for retaining a physical gift card to a physical display in a retail environment, the apparatus including: a unidirectional card removal component comprising perforations, and a gift card removably attached to the unidirectional card removal component along the perforations, the gift card being removable in one direction by detaching the gift card from the unidirectional card removal component along the perforations.

The apparatus can optionally include one or more of the following features. For example, the apparatus can include identifying information associated with the gift card being applied onto a surface of the unidirectional card removal component. The unique identifying information can include a card number associated with the gift card. The unique identifying information can further be applied onto a surface of the gift card. The gift card can include preprinted paper. The gift card can include a generic barcode or SKU applied to a surface of the gift card at a time of manufacturing the unidirectional card removal component and the gift card attached thereto. The unidirectional card removal component can include a perforated hanger. The apparatus further may include a locking peg hook that can be configured to retain the unidirectional card removal component to the physical display in the retail environment, the unidirectional card removal component being non-removable from the locking peg hook.

One or more embodiments described herein can include a system for performing a gift card purchase and activation in a retail environment, the system including: a card retention apparatus having a unidirectional card removal component and a gift card, the gift card being removable from the card retention apparatus using the unidirectional card removal component, a point of sale (POS) terminal that can be configured to process a purchase and activation of the gift card that is removed from the card retention apparatus, a card identifier and access code system in network communication with the POS terminal and that can be configured to assign unique identifying information to the gift card in response to the purchase and activation of the gift card at the POS terminal, and a printing device in network communication with the POS terminal and that can be configured to execute instructions received from the POS terminal to apply at least a portion of the unique identifying information onto a surface of the gift card. The POS terminal can be configured to perform operations that include: identifying the gift card for purchase and activation, receiving a payment for the purchase and activation of the identified gift card, identifying the unique identifying information on a sticker that is affixed to the gift card in response to receiving and processing the payment, and returning, to the card identifier and access code system, the unique identifying information and an identifier for the identified gift card. The card identifier and access code system can be configured to store, in a data store, the unique identifying information from the sticker in association with the identifier for the identified gift card.

The system can optionally include one or more of the abovementioned features.

The devices, system, and techniques described herein may provide one or more of the following advantages. For example, the disclosed technology can limit or otherwise prevent an ability of users to steal gift card PINs and by associating and applying PINs or other unique card information onto gift cards at a time that such gift cards are purchased during checkout, the disclosed technology can eliminate an opportunity for users to steal the PINs and subsequently drain card funds upon activation of those cards. The disclosed technology can similarly ensure that gift card purchasers can use their gift cards without issue (e.g., funds are not depleted by the time they receive and use their gift cards). Moreover, the disclosed technology can improve customer experiences with the retail environment.

As another example, data encryption techniques can be used to ensure that unique identifying information for gift cards may not be intercepted during transmission between different system components (e.g., POS terminals, remote computer systems, printing devices). Similarly, the disclosed technology can leverage one or more obfuscation techniques with printing instructions to ensure that the unique identifying information for the gift cards are not compromised during transmission between the different system components and/or during application of the unique identifying information on the gift cards.

Moreover, the disclosed techniques may provide for encoding intended regions of a retail environment (e.g., store) in the unique identified information for the gift cards, which can be used to improve detection of chain of custody and/or potential issues in gift card shipment. The disclosed techniques may also implement predictable algorithms, models, and other techniques having normal and/or even distributions, so even without knowing generated numbers for the gift cards, the predictable algorithms may be used to identify patterns and/or digits or other values that appear more frequently than the retail environment's distribution dictates. Such identifications can be used to determine that fake or false identifying information is being inserted onto the gift cards.

The details of one or more implementations are set forth in the accompanying drawings and the description below. Other features and advantages will be apparent from the description and drawings, and from the claims.

### BRIEF DESCRIPTION OF THE DRAWINGS

FIG. 1 is a conceptual diagram of a system for purchasing and activating a physical gift card using the disclosed techniques.

FIG. 2 is a system diagram of components used for performing the disclosed techniques.

FIG. 3A is a conceptual diagram of an example system for assigning and applying a PIN for a gift card at a time of purchase during checkout.

FIG. 3B is a conceptual diagram of an example system for assigning and applying a card number for a gift card at a time of purchase during checkout.

FIG. 3C is a conceptual diagram of an example system for assigning and applying a PIN and a card number for a gift card at a time of purchase during checkout.

FIG. 3D is a conceptual diagram of an example system for assigning and applying a PIN and/or a card number for a gift card at a time of purchase using obfuscation printing techniques.

FIG. 3E is a conceptual diagram of an example system for assigning and printing a PIN and/or a card number for a gift card at a time of purchase using secure printing instructions.

FIG. 4 is a conceptual diagram of a system for purchasing and activating a physical gift card with a sticker having a PIN.

FIG. 5 is a flowchart of a process for assigning and activating a physical gift card with unique identifying card information at a time of purchase during checkout.

FIG. 6 is a flowchart of a process for determining whether a checkout device has been compromised during purchase and/or activation of a physical gift card using the checkout device.

FIG. 7 is a schematic diagram that shows an example of a computing device and a mobile computing device.

In the present disclosure, like-numbered components of various embodiments generally have similar features when those components are of a similar nature and/or serve a similar purpose, unless otherwise noted or otherwise understood by a person skilled in the art.

### DETAILED DESCRIPTION OF ILLUSTRATIVE EMBODIMENTS

This disclosure generally relates to systems, methods, apparatus, and techniques for generating physical gift cards that are securely associated with unique identifying card information. Physical gift cards can be provided on preprinted paper (e.g., instead of plastic). A gift card can be printed with a generic gift card barcode or SKU. Sometimes, the gift card can be printed with a gift card number as well. In some implementations, the gift card can be preprinted with a barcode/covered PIN. During a purchase/activation process, another activation barcode can be determined and applied to the gift card. This activation barcode and the PIN may be used in combination for activating and/or using the gift card. After all, the PIN is a value that may never be scanned or transmitted over wires until a guest scratches off a protective material covering the PIN. The disclosed techniques can be used to improve the security of gift cards.

The gift card can be attached to a display at a shelf in a retail environment. The display can include a perforated hanger. The display can include a locking peg hook. When a user desires to purchase the gift card, they can tear the gift card from the display along the perforated hanger. As a result, the gift card may not be returned to the display once removed. The gift card can be brought to a checkout terminal for purchase. The barcode on the card may be scanned at a POS terminal of the checkout terminal. Once the user pays for the gift card, a PIN (e.g., an access code) and/or a card number can be assigned to the gift card (e.g., by the POS terminal and/or by a computer system in communication with the POS terminal). The assignment can be performed with encryption techniques. The POS terminal and/or a computer system can also generate instructions for printing the assigned PIN and/or card number onto the gift card. The instructions can be transmitted to a printing device at the checkout terminal, which can print the PIN and/or card number onto the gift card as part of the checkout process. Using the disclosed technology, the PIN and/or the card number may not be known for the gift card until point of purchase after the user paid for the card. Accordingly, a risk that the gift card may be compromised can be diminished or otherwise eliminated.

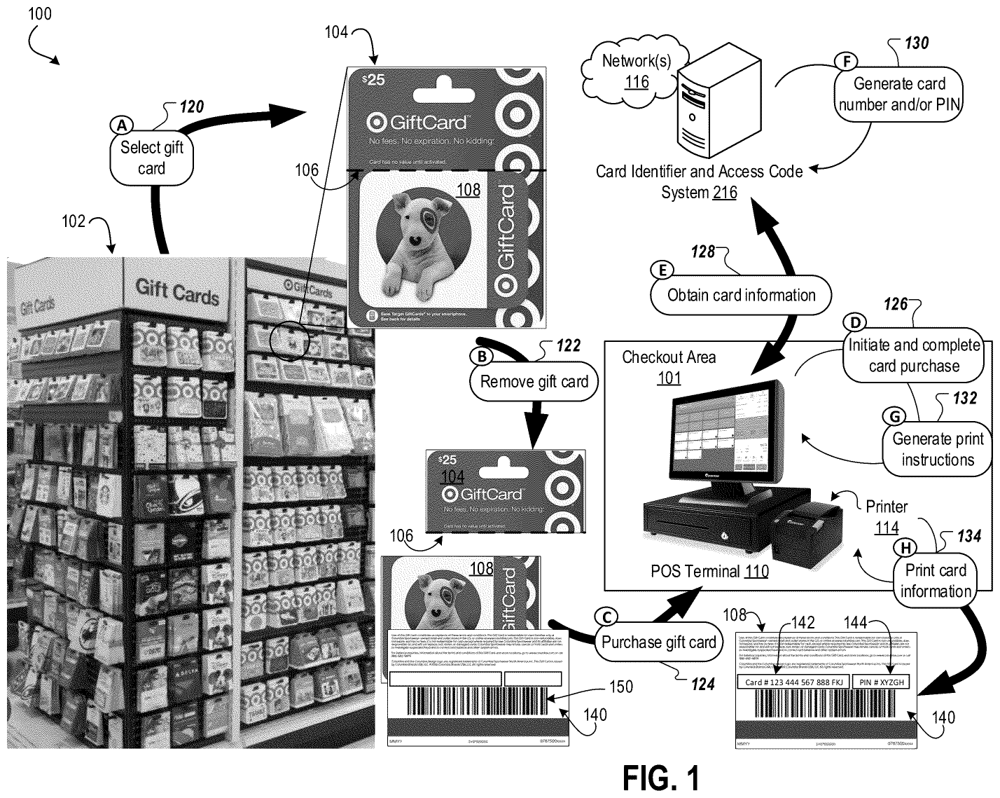

Referring to the figures, FIG. 1 is a conceptual diagram of a system 100 for purchasing and activating a physical gift card 108 using the disclosed techniques. The system 100 can be implemented in a retail environment, such as a store. The system 100 can include a gift card display 102, which may include various different gift cards for purchase, such as the gift card 108. The display 102 can be positioned anywhere inside the retail environment. The gift card 108, and any of the other gift cards at the display 102, can be attached to a retention apparatus 104. The retention apparatus 104 can be part of the display 102 and/or attached to a locking peg hook of the display 102. The retention apparatus 104 can be a perforated hanger having perforations 106 along an edge that connects to the gift card 108. A user who wishes to purchase the gift card 108 can tear the gift card 108 off of the retention apparatus 104 along the perforations 106, thereby removing the gift card 108 from the display 102.

The system 100 can also include a POS terminal 110 and a printer 114 in a checkout area 101. In some implementations, the retail environment can include a plurality of checkout lanes, checkout terminals, and/or checkout stations in the checkout area 101, each checkout location having a respective POS terminal and a respective printer. The checkout area 101 can include checkout locations that are operated by employees or other relevant users working in the retail environment. Sometimes, the checkout area 101 can include one or more self-checkout stations.

The POS terminal 110 can be configured to perform, process, and complete a checkout process in the checkout area 101. For example, the POS terminal 110 can include one or more scanning devices and/or displays. The POS terminal 110 can be used to scan items for purchase by a user, present transaction information for the scanned items, receive payment information for the scanned items, and complete the checkout process for the scanned items.

The printer 114 can be a printing machine and/or device that is configured to print information related to the checkout process performed by the POS terminal 110. The printer 114 can, for example, receive printing instructions from the POS terminal 110 to print unique identifying card information onto the card 108 at a time of purchase, as described further below.

The POS terminal 110 can communicate (e.g., wired, wirelessly) via network(s) 116 with a card identifier and access code system 216. The system 216 can be any type of computing system, network of computing devices, cloud-based computing system, and/or remote computing system. In some implementations, the system 216 can be part of the POS terminal 110. The system 216 can be configured to generate, assign, and/or associate the unique identifying card information with the card 108 at the time of purchase, as described further below.

Still referring to FIG. 1, a user (e.g., shopper, customer, end user, guest) can select the gift card 108 from the display 102 (block A, 120). Selecting the gift card 108 can include removing the gift card 108 from the retention apparatus 104 by tearing the gift card 108 along the perforations 106 to separate the gift card 108 from the retention apparatus 104 (block B, 122). In some implementations, the gift card 108 can be preprinted paper, making it easier for the user to separate the gift card 108 from the retention apparatus 104 than if the gift card 108 were made from a plastic-like material. The gift card 108 can be made with paper having approximately 0.406 mm/0.16 inch maximum thickness. The gift card 108 can be made with paper having one or more different dimensions and/or thicknesses. In some implementations, the gift card 108 and the retention apparatus 104 can be made from the plastic-like material, and the gift card 108 can be torn off of the retention apparatus along the perforations 106.

The gift card 108 may include a barcode 150 (e.g., SKU) on a back surface 140 of the gift card 108. The barcode 150 can be a generic gift card number for identifying gift cards in the system 100. In the example of FIG. 1, the back surface 140 of the gift card 108 does not include a card number 142 or a PIN 144 at the time that the gift card 108 is removed from the retention apparatus 104 (block B, 122). In other words, when the gift card 108 is printed and then placed at the display 102, the gift card 108 does not include preprinted information such as the card number 142 and the PIN 144. Such unique identifying card information can be assigned to the gift card 108 at a time or purchase, as described below.

Once the gift card 108 is removed in block B (122), the user can bring the gift card 108 to the checkout area 101 to purchase the gift card 108 (block C, 124).

The POS terminal 110 can initiate and complete the card purchase in block D (126). For example, an employee or other relevant user at the POS terminal 110 can use a scanning device to scan the barcode 150 on the back surface 140 of the gift card 108. As a result of the scanning, the gift card 108 can be added to a transaction for the user purchasing the gift card 108. The user purchasing the gift card 108 can provide a form of payment, which can be processed by the POS terminal 110 to complete the card purchase.

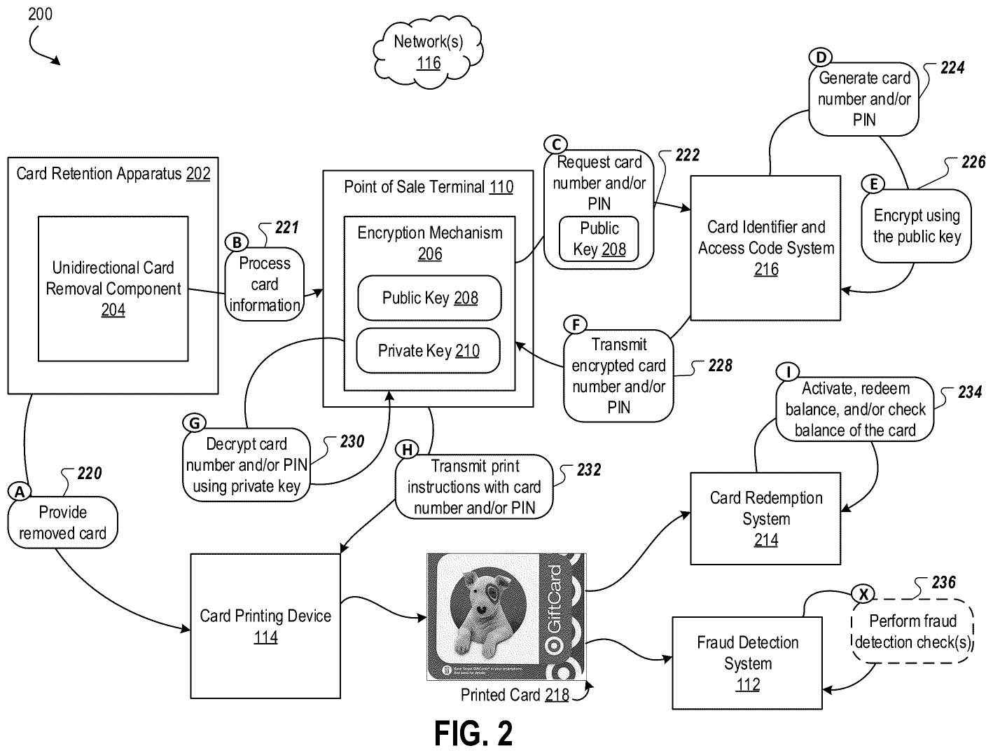

Once the card purchase is completed, the POS terminal 110 can communicate with the card identifier and access code system 216 to obtain card information for the purchased gift card 108 (block E, 128). This communication can be performed securely, with one or more encryption techniques described further in reference to FIG. 2.

The system 216 can generate the unique identifying information for the gift card 108, such as a card number and/or a PIN (block F, 130). Sometimes, the system 216 can generate and assign both the card number and the PIN to the gift card 108. Sometimes, the system 216 may generate and assign only one of the card number and the PIN to the gift card 108. By generating and assigning only one of the card number and the PIN, the gift card 108 balance may remain secured if communication between the system 216, the POS terminal 110, and/or the printer 114 is compromised. The generated card number and/or the PIN can be transmitted securely back to the POS terminal 110 (block E, 128).

Using this obtained card information, the POS terminal 110 can generate print instructions in block G (132). As described in reference to FIG. 2, the POS terminal 110 may decrypt the obtained card information then generate the instructions for printing the decrypted card information onto the gift card 108. The print instructions can be provided to the printer 114, which can print the card information onto the gift card 108 (block H, 134).

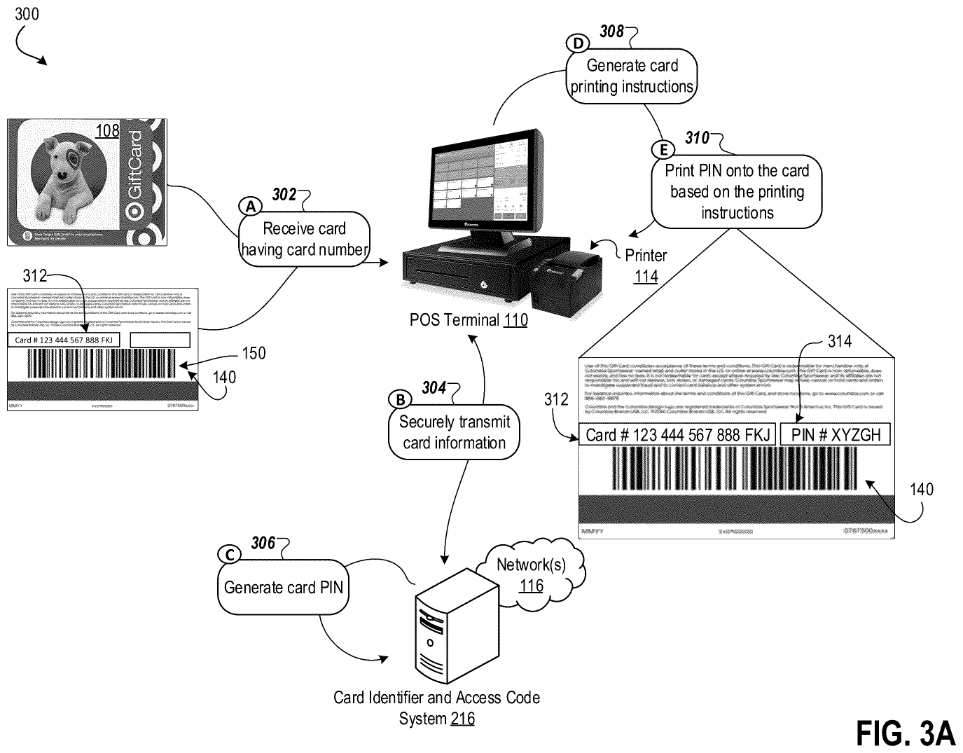

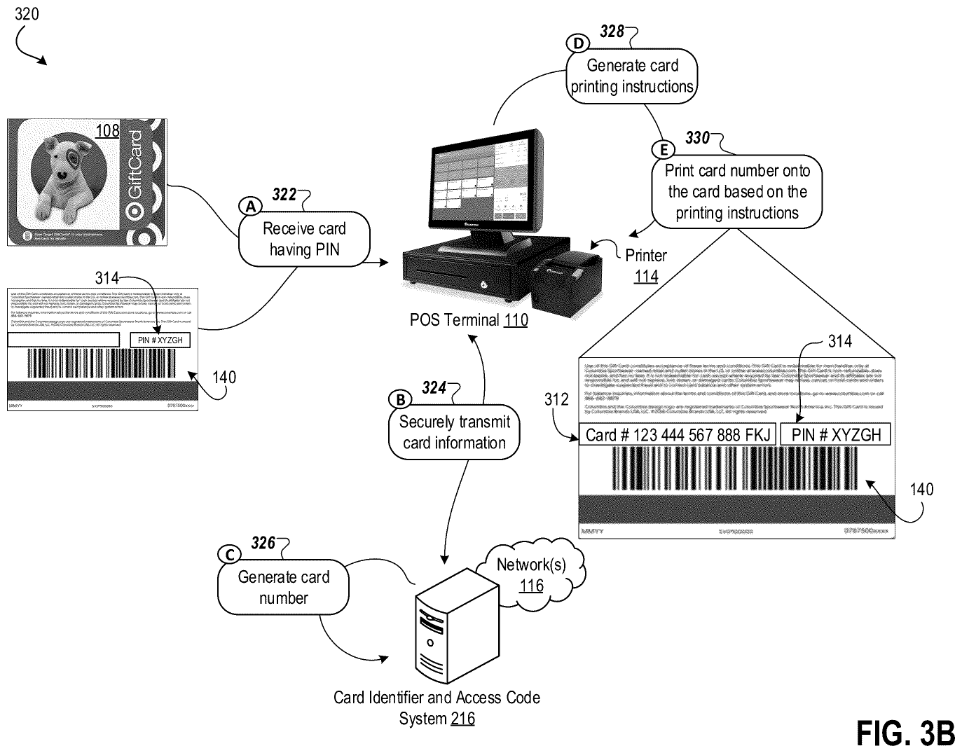

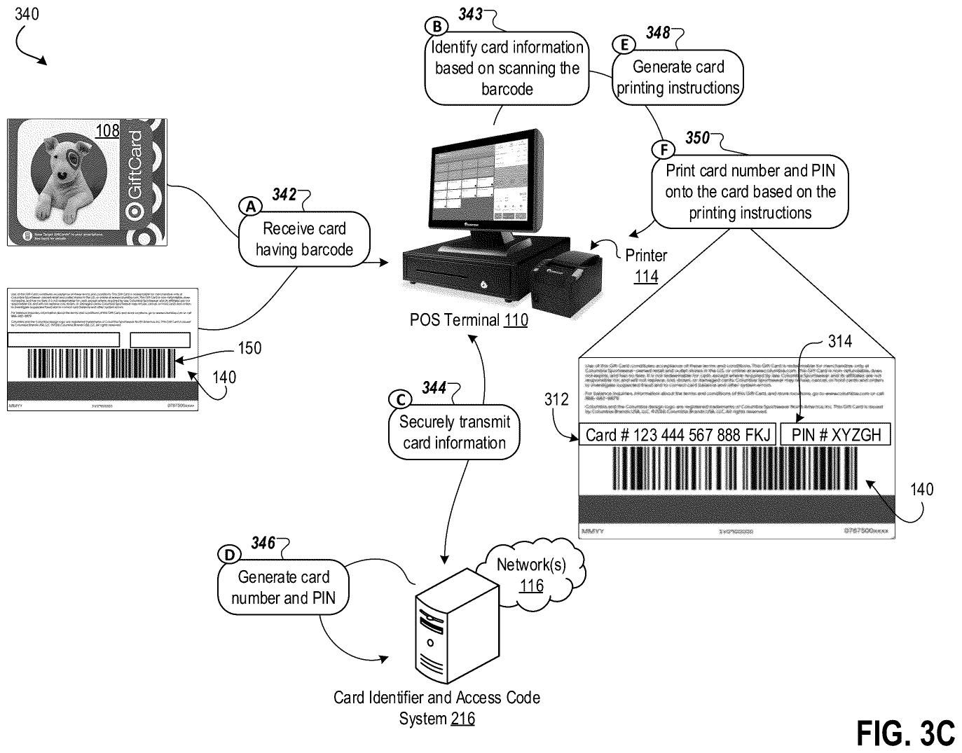

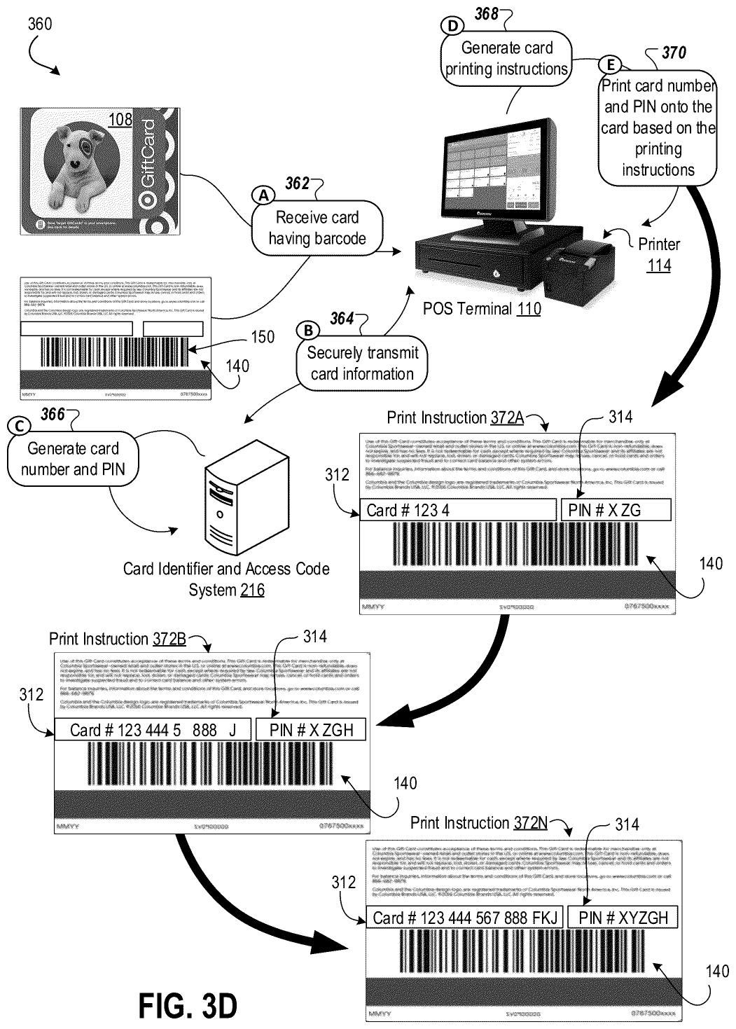

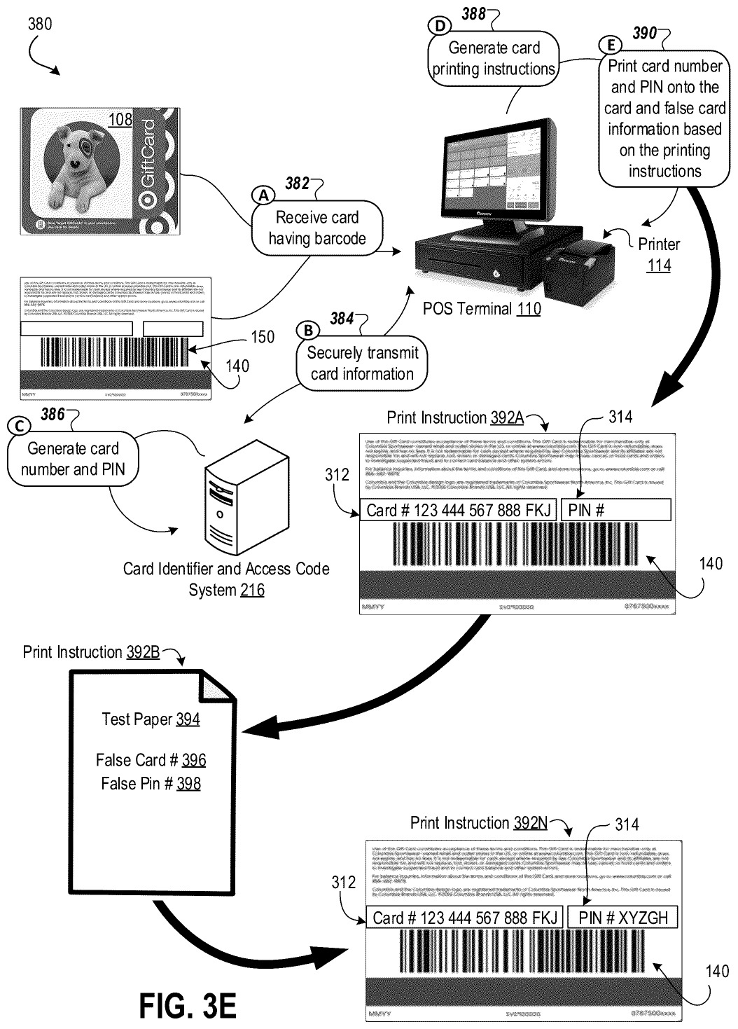

For example, once the gift card 108 is purchased/paid for (block D, 126), the employee or other relevant user can provide or otherwise feed the gift card 108 into the printer 114. Once the printer 114 receives the print instructions, the instructions can be executed to print one or more of the card number and the PIN onto the back surface 140 of the gift card 108. The printer 114 may execute instructions to print the generated card number (block F, 130) as the card number 142 on the back surface 140 of the gift card 108. Additionally or alternatively, the printer 114 may execute instructions to print the generated PIN as the PIN number 144 on the back surface 140 of the gift card 108. Refer to FIGS. 3A, 3B, 3C, 3D, and 3E for further discussion about printing the unique identifying information onto the gift card 108.

Although the system 100 is described from the perspective of the checkout area 101 having an employee or other relevant user that performs a checkout process, the system 100 may also be implemented in self-checkout scenarios.

In some implementations, the gift card 108 can be preprinted and only available in the checkout area 101. In other words, the user may not view the gift card 108 at the display 102 or separate the gift card 108 from the retention apparatus 104. Instead, the user can approach the checkout area 101 and ask the employee or other relevant user at the checkout area 101 to purchase the gift card 108. The employee can then remove the gift card 108 from a designated location in the checkout area 101 (e.g., a particular drawer at the POS terminal 110) and then continue through the blocks D-H (126-134) described in FIG. 1 to complete purchase and activation of the gift card 108.

FIG. 2 is a system diagram of components used for performing the disclosed techniques. System 200 can include the POS terminal 110, the card identifier and access code system 216, the card printing device 114, a card retention apparatus 202, a fraud detection system 112, and a card redemption system 214. The components 110, 216, 114, 202, 112, and 214 can communicate (e.g., wirelessly, wired) via the network(s) 116.

The card retention apparatus 202 can be configured to retain a gift card at a display in the retail environment until the gift card is selected by a user for purchase. As described in reference to FIG. 1, the apparatus 202 can include a unidirectional card removal component 204. The component 204 can include a physical setup that once something is removed, it cannot be put back. In some implementations, the component 204 can be locked (e.g., locked to a hanger on a display and/or shelf in the retail environment) and may require the user to pull the gift card off of the component 204. For example, the component 204 can be a perforated surface of the apparatus 202 that allows the user to tear the gift card off of the apparatus 202 along the perforations. Once the gift card is separated from the apparatus 202, the gift card cannot be put back or otherwise attached to the apparatus 202. Refer to the retention apparatus 104, the perforations 106, and the gift card 108 at the display 102 described in FIG. 1 for further discussion.

The POS terminal 110, as described in FIG. 1, can be configured to process and/or complete purchases during a checkout process in the retail environment, such as a purchase of the gift card that is removed from the card retention apparatus 202. A checkout area in the retail environment can include a plurality of POS terminals 110. The POS terminal 110 can include scanning devices, input devices (e.g., touch screens, keyboards, microphones, mice, payment-receiving devices), and output devices (e.g., display screens, speakers, printers). The POS terminal 110 can include an encryption mechanism 206, which can be configured to encrypt and/or decrypt unique identifying information for gift cards that are purchased and activated using the system 200. Accordingly, the encryption mechanism 206 can store/maintain a public key 208 and/or a private key 210 that correspond to the gift card that is being purchased/activated. The keys 208 and 210 can be used, as described herein, to secure the unique identifying information for the gift card as such information is stored and/or transmitted between components of the system 200.

The card identifier and access code system 216, as described in reference to FIG. 1, can be any type of computing system configured to securely generate the unique identifying information for the gift card at a time that the gift card is purchased and activated.

The card printing device 114, as described in reference to FIG. 1, can be configured to receive instructions from the POS terminal 110 to print/apply one or more of the unique identifying information onto the gift card once the gift card is purchased and activated. In some implementations, the device 114 can be a printer that is separate from the POS terminal 110 but in wired and/or wireless communication/connection with the POS terminal 110. Sometimes, the device 114 can be part of or otherwise integrated into the POS terminal 110.

The fraud detection system 112 can be configured to perform one or more techniques to determine whether communication between the system 200 components is compromised. For example, the system 112 can be any type of computing system described herein and configured to determine whether the communication between the POS terminal 110 and the card printing device 114 is compromised. The system 112 can identify patterns of gift card compromises at the retail environment to determine whether a particular POS terminal 110 in the retail environment is vulnerable (or most vulnerable) to being compromised. To identify communication compromises, the system 112 can, in some implementations, transmit false or fake printing instructions to the card printing device 114 to see whether those instructions pass to the device 114 correctly. The printing instructions can be transmitted at random intervals and/or predetermined time intervals. If the instructions do not pass to the device 114 correctly, the system 112 may determine that communication between the particular POS terminal 110 and the device 114 has been compromised. In some implementations, the system 112 can include an Arduino, which may be configured to the communication line/wire between the POS terminal 110 and the device 114 and used to determine whether the fake instructions pass correctly between the components. Sometimes, the fraud detection techniques may not be performed. Sometimes, the system 112 may perform the fraud detection techniques upon receiving a request from another computing system in the retail environment.

The card redemption system 214 can be any type of computing system described herein configured to determine and/or identify when and if a gift card has been activated and/or a remaining balance on the gift card. For example, the system 214 can be used to access and load unique identifying information for the gift card (e.g., a PIN and/or card number) to verify that such information has been associated with the gift card and/or a balance has been added to the gift card. A user of the gift card may also access or poll the system 214 (e.g., using their user computing device) to check the remaining balance of the gift card and/or use the gift card to make one or more purchases.

Still referring to the system 200 in FIG. 2, a user can remove the gift card from the card retention apparatus 202 using the unidirectional card removal component 204, then provide the removed card to the card printing device 114 (block A, 220). For example, the user can bring the gift card to a checkout area in the retail environment and hand the gift card to an employee at the POS terminal 110. The employee can then provide the card to the device 114 (e.g., insert the card into a slot or other receiver of the device 114 that may be configured to receive paper, such as the card).

The POS terminal 110 can process card information for the gift card in block B (221). For example, the employee can scan a barcode on a back surface of the gift card as part of performing a process to purchase the card during a checkout process. Processing the card information can include receiving payment from the user to apply a balance to the gift card. Processing the card information can include processing the payment and completing the purchase of the gift card. Processing the card information can include, in some implementations, generating the public key 208 and the private key 210 for the particular gift card using the encryption mechanism 206.

As part of processing the card information, the POS terminal 110 can request a unique card number and/or PIN for the gift card from the card identifier and access code system 216 (block C, 222). The encryption mechanism 206 of the POS terminal 110 can provide the public key 208 in the request to the system 216.

The system 216 can then generate the card number and/or the PIN for the gift card in block D (224). Sometimes, the system 216 can randomly generate the card number and/or the PIN. Sometimes, the system 216 can select one or more previously-generated values for the card number and/or the PIN. In some implementations, the gift card may already be associated with a card number and/or PIN. Therefore, the system 216 can use the public key 208 to identify the association between the gift card and the card number/PIN in block D (224).

Once the card number and/or the PIN is/are generated, the system 216 can encrypt the card information using the public key 208 (block E, 226). The system 216 can securely transmit the encrypted card number and/or PIN back to the POS terminal 110 in block F (228).

The encryption mechanism 206 of the POS terminal 110 can be configured to decrypt the card number and/or PIN using the private key 210 (block G, 230).

Once decrypted, the POS terminal 110 can generate and transmit print instructions to the card printing device 114 (block H, 232). The print instructions can indicate how to print/apply the card number and/or PIN onto a surface of the gift card, such as the back surface of the gift card. Refer to FIGS. 3A, 3B, 3C, 3D, and 3E for further description about the print instructions.

The card printing device 114 can print/apply the card number and/or PIN onto the gift card that was provided in block A (220) according to the print instructions. The device 114 can therefore output a printed card 218, which can be handed back to the user at completion of the checkout process.

The user, the employee, or any other relevant user (such as a person who receives the gift card as a gift from the user) can access the card redemption system 214 to activate, redeem the balance, and/or check the balance of the gift card (block I, 234). Block I, 234, can be performed any time after the printed gift card 218 is outputted from the card printing device 114 and/or the purchase/checkout process of the card is complete.

As described above, the fraud detection system 112 can be configured to optionally perform one or more fraud detection check(s) (block X, 236). Block X (236) can be performed before, during, or after any of the blocks described in FIG. 2. For example, block X (236) can be performed before, during, or after transmission of the print instructions between the POS terminal 110 and the card printing device 114.

FIG. 3A is a conceptual diagram of an example system 300 for assigning and applying a PIN for a gift card at a time of purchase during checkout. The system 300 can include the POS terminal 110, the printer 114, and the card identifier and access code system 216, which communicate via the network(s) 116, as described in reference to FIGS. 1-2. In the example system 300, the gift card 108 can be pre-printed with a card number 312 on the back surface 140 of the card 108, but may not have a PIN until the gift card 108 is purchased at the POS terminal 110. A PIN 314 can be generated and assigned to the particular gift card 108 during checkout, then printed onto the back surface 140 of the card 108.

As shown in FIG. 3A, the POS terminal 110 can receive the gift card 108 having the card number 312 pre-printed onto the back surface 104 of the card 180 (block A, 302). The barcode 150 on the back surface 104 can be scanned using a scanning device at the POS terminal 110 to identify card information and ring up the gift card 108 for purchase. In some implementations, instead of scanning the barcode 150, the card number 312 can simply be inputted into the POS terminal 110.

The POS terminal 110 can securely transmit the card information to the card identifier and access code system 216 (block B, 304). For example, the card information can include the card number 312. As another example, the card information can include other identifying information that is associated with the scanned barcode 150. Refer to FIG. 2 for further description about encrypting, decrypting, and securely transmitting the card information.

The system 216 can generate the PIN 314 for the gift card 108 based on the received card information and using one or more encryption techniques described herein (block C, 306). Generating the PIN 314 can include associating the gift card 108 with the PIN 314. The PIN 314 can be previously generated/created. In some implementations, the PIN 314 can be generated in real-time, in response to receiving the card information in block B (304). The PIN 314 can be securely transmitted back to the POS terminal 110 (block B, 304).

The POS terminal 110 can then generate card printing instructions in block D (308). For example, the POS terminal 110 can generate instructions to print the PIN 314 on a particular portion/location of the back surface 140 of the gift card 108.

The instructions can be transmitted to the printer 114 and automatically executed to print the PIN 314 onto the card 108 (block E, 310).

Once the PIN 314 is printed onto the card 108, the card comprises the card number 312 and the PIN 314, both of which can be used by the user or another user to redeem a balance/funds linked to the card 108. The card 108 can then be used to make one or more purchases.

In some implementations, when the gift card 108 is pre-printed with the card number 312, the same card number 312 can also be pre-printed onto a display and/or retention apparatus to which the gift card 108 is originally attached. Therefore, once the gift card 108 is separated from/torn off of the retention apparatus, the gift card 108 can be appropriately audited. In other words, an employee or other relevant user in the retail environment can identify card numbers on the retention apparatus and whether a gift card associated with an identified card number has been removed from the retention apparatus. The identified card number can be checked against records maintained by/accessed via the card identifier and access code system 216 (and/or the card redemption system 214 in FIG. 2) to determine whether the associated gift card has been purchased, assigned a PIN number, activated, redeemed, and/or used. These techniques can be used by the retail environment to keep track of gift card sales/purchases.

FIG. 3B is a conceptual diagram of an example system 320 for assigning and applying the card number 312 for the gift card 108 at a time of purchase during checkout. In comparison to the system 300 in FIG. 3A, in the system 320, the card 108 can be pre-printed and/or assigned the PIN 314 but not the card number 312. Therefore, the system 320 can be used to generate, assign, and/or print the card number 312 onto the card 108.

Similar to the blocks described in reference to the system 300 of FIG. 3A, the POS terminal 110 can receive the gift card 108 having the PIN 314 pre-printed onto the back surface 140 of the card 108 (block A, 322).

The POS terminal 110 can securely transmit card information to the card identifier and access code system 216 (block B, 324). The card information can include the PIN 314, which has already been generated and assigned to the card 108 and/or pre-printed onto the card 108.

Using the card information, the system 216 can generate the card number 312 for the card 108 in block C (326). The system 216 can then securely transmit the card number 312 back to the POS terminal 110 as part of the card information (block B, 324).

The POS terminal 110 can generate instructions to print/apply the card number 312 onto the card 108 based on the securely transmitted card information (block D, 328).

Accordingly, the printer 114 can execute the instructions to print the card number 312 onto the back surface 140 of the gift card 108 (block E, 330).

FIG. 3C is a conceptual diagram of an example system 340 for assigning and applying the PIN 314 and the card number 312 for the gift card 108 at a time of purchase during checkout. In comparison to the system 300 in FIG. 3A and the system 320 in FIG. 3B, in the system 340, the card 108 may not be pre-assigned the PIN 314 and the card number 312. Therefore, the card 108 can be pre-printed with empty spaces on the back surface 140 of the card 108, where the PIN 314 and the card number 312 can eventually be printed (e.g., once assigned to the card 108 during the checkout process).

Similar to the blocks described in reference to the system 300 of FIG. 3A, the POS terminal 110 can receive the gift card 108 having the barcode 150 (e.g., SKU) on the back surface 140 of the card 108 (block A, 342).

The POS terminal 110 can identify card information for the card 108 based on scanning the barcode 150, as described herein (block B, 343). The POS terminal 110 can then securely transmit the card information to the card identifier and access code system 216 (block C, 344).

Using the card information, the system 216 can generate the card number 312 and the PIN 314 for the card 108 in block D (346). The system 216 can securely transmit the card number 312 and the PIN 314 back to the POS terminal 110 as part of the card information (block C, 344). Sometimes, the card number 312 and the PIN 314 can be transmitted separately to make it challenging to intercept two different values needed to create a valid gift card. In some implementations, as described herein, the card number 312 may be preprinted on the gift cards and then only the PIN 314 is transmitted and then applied to the gift cards at a time of card activation. As another example, the PIN 314 can be predetermined and preprinted onto the gift card 108. The PIN 314 may be covered with a protective film/material. At time of card activation, a second activation barcode can be determined and then applied to the card 108 using the techniques described herein. The card 108 may be activated and/or used based on scanning a combination of the preprinted PIN 314 and the second activation barcode.

The POS terminal 110 can generate instructions for printing/applying the card number 312 and the PIN 314 onto the back surface 140 of the card 108 in block E (348), based on the received card information. Accordingly, the printer 114 can execute the instructions to print the card number 312 and the PIN 314 onto the back surface 140 of the gift card 108 (block F, 350).

FIG. 3D is a conceptual diagram of an example system 360 for assigning and printing the PIN 314 and/or the card number 312 for the gift card 108 at a time of purchase using obfuscation printing techniques. Although the system 360 is described from the perspective of generating, assigning, and printing both the PIN 314 and the card number 312, the system 360 can also be used to generate, assign, and print one of the PIN 314 and the card number 312. Any of the techniques described in reference to the system 300 of FIG. 3A, the system 320 of FIG. 3B, and the system 340 of FIG. 3C can be performed using the system 360. Moreover, the system 360 can include additional obfuscation techniques for ensuring secure printing of the PIN 314 and/or the card number 312 onto the gift card 108.

Similar to the blocks described in reference to FIGS. 3A, 3B, and 3C, the POS terminal 110 can receive the gift card 108 having the barcode 150 (e.g., SKU) on the back surface 140 of the card 108 (block A, 362). In some implementations as described in FIG. 3A, the card 108 can include the card number 312, which can be received in block A (362). Sometimes, as described in FIG. 3B, the card 108 can include the PIN 314, which can be received in block A (362).

The POS terminal 110 can securely transmit card information to the card identifier and access code system 216 (block B, 364). Sometimes, as described in reference to FIG. 3C, the POS terminal 110 can identify card information for the card 108 based on scanning the barcode 150. The POS terminal 110 can securely transmit whichever of the card number 312 and the PIN 314 that may be provided with the card 108 in block A (362), in some implementations.

Using the card information, the system 216 can generate the card number 312 and the PIN 314 for the card 108 in block C (366). The system 216 can securely transmit the card number 312 and the PIN 314 back to the POS terminal 110 as part of the card information (block B, 364).

The POS terminal 110 can generate instructions for printing the card number 312 and the PIN 314 onto the back surface 140 of the card 108 in block D (368), based on the received card information. Accordingly, the printer 114 can execute the instructions to print the card number 312 and the PIN 314 onto the back surface 140 of the gift card 108 (block E, 370).

Generating the instructions in block D (368) can include generating a plurality of print instructions 372A-N, which can be executed by the printer 114 (block E, 370) to translate and obfuscate the card number 312 and the PIN 314. Beneficially, the obfuscation techniques provided by the print instructions 372A-N can help mitigate or otherwise prevent potential actors or users from intercepting transmission of the print instructions 372A-N between the POS terminal 110 and the printer 114. As a result, the card number 312 and the PIN 314 can be securely printed onto the gift card 108 without risking a balance of the card 108 becoming compromised.

The print instructions 372A-N can be transmitted and/or executed in series, sequentially, in parallel, and/or in one or more randomized orders. Each of the print instructions 372A-N, when executed by the printer 114, may cause the printer 114 to print a portion or subset of one or more of the card number 312 and the PIN 314 onto the back surface 140 of the gift card 108. In the illustrative example of FIG. 3D, the first print instructions 372A cause the printer 114 to print a first 4 characters of the card number 312 and first, third, and fourth characters of the PIN 314. The second print instructions 372B cause the printer 114 to print fifth, sixth, seventh, tenth, eleventh, twelfth, and fifteenth characters of the card number 312 and a fifth character of the PIN 314. The illustrative last print instructions 372N cause the printer 114 to print remaining characters of the card number 312 and a second character of the PIN 314.

One or more other obfuscated, randomized, and/or algorithmic patterns of character printing can be determined by the POS terminal 110 and provided as the print instructions 372A-N to the printer 114. For example, the print instructions 372A-N can cause the printer 114 to print one or more predetermined quantities of characters in one or more positions A-N for the card number 312 before printing one or more other predetermined quantities of characters in one or more other positions A-N for the PIN 314, and vice-versa.

FIG. 3E is a conceptual diagram of an example system 380 for assigning and printing the PIN 314 and/or the card number 312 for the gift card 108 at a time of purchase using secure printing instructions. Although the system 380 is described from the perspective of generating, assigning, and printing both the PIN 314 and the card number 312, the system 380 can also be used to generate, assign, and print one of the PIN 314 and the card number 312. Any of the techniques described in reference to the system 300 of FIG. 3A, the system 320 of FIG. 3B, the system 340 of FIG. 3C, and the system 360 of FIG. 3D can be performed using the system 380. Moreover, the system 380 can include additional obfuscation techniques for ensuring secure printing of the PIN 314 and/or the card number 312 onto the gift card 108.

Similar to the blocks described in reference to FIGS. 3A, 3B, 3C, and 3D, the POS terminal 110 can receive the gift card 108 having the barcode 150 (e.g., SKU) on the back surface 140 of the card 108 (block A, 382). In some implementations as described in FIG. 3A, the card 108 can include the card number 312, which can be received in block A (382). Sometimes, as described in FIG. 3B, the card 108 can include the PIN 314, which can be received in block A (382).

The POS terminal 110 can securely transmit card information to the card identifier and access code system 216 (block B, 384). Sometimes, as described in reference to FIG. 3C, the POS terminal 110 can identify card information for the card 108 based on scanning the barcode 150. The POS terminal 110 can securely transmit whichever of the card number 312 and the PIN 314 that may be provided with the card 108 in block A (382), in some implementations.

Using the card information, the system 216 can generate the card number 312 and the PIN 314 for the card 108 in block C (386). The system 216 can securely transmit the card number 312 and the PIN 314 back to the POS terminal 110 as part of the card information (block B, 384).

The POS terminal 110 can generate instructions for printing the card number 312 and the PIN 314 onto the back surface 140 of the card 108 in block D (388), based on the received card information. Accordingly, the printer 114 can execute the instructions to print the card number 312 and the PIN 314 onto the back surface 140 of the gift card 108 (block E, 390).

Generating the instructions in block D (388) can include generating a plurality of print instructions 392A-N, which can be executed by the printer 114 (block E, 390) to help mitigate or otherwise prevent potential actors or users from intercepting transmission of the print instructions 392A-N between the POS terminal 110 and the printer 114. As a result, the card number 312 and the PIN 314 can be securely printed onto the gift card 108 without risking a balance of the card 108 becoming compromised.

The print instructions 392A-N can be transmitted and/or executed in series, sequentially, in parallel, and/or in one or more randomized orders. Each of the print instructions 392A-N, when executed by the printer 114, may cause the printer 114 to print one or more fake or false (e.g., random) numbers or characters onto paper 394 before, during, and/or after printing the actual card number 312 and/or the actual PIN 314 onto the back surface 140 of the card 108.

In the illustrative example of FIG. 3E, the first print instructions 392A can cause the printer 114 to print the full card number 312 onto the back surface 140 of the card 108 but not print the PIN 314. The second print instructions 392B can cause the printer 114 to print at least one of a false card number 396 and a false PIN 398 onto the test paper 394. At the same or different time, the first or other print instructions 392A-N can also be executed. The illustrative example of the last print instructions 392N can cause the printer 114 to print the PIN 314 onto the back surface 140 of the gift card 108.

One or more other obfuscated, randomized, and/or algorithmic patterns of false printing instructions can be determined by the POS terminal 110 and provided as the print instructions 392A-N to the printer 114. For example, the print instructions 392A-N can cause the printer 114 to print one or more predetermined quantities of characters in one or more positions A-N for the card number 312 before printing one or more other predetermined quantities of characters in one or more other positions A-N for the PIN 314, and vice-versa on one or more of the gift card 108 and the test paper 394.

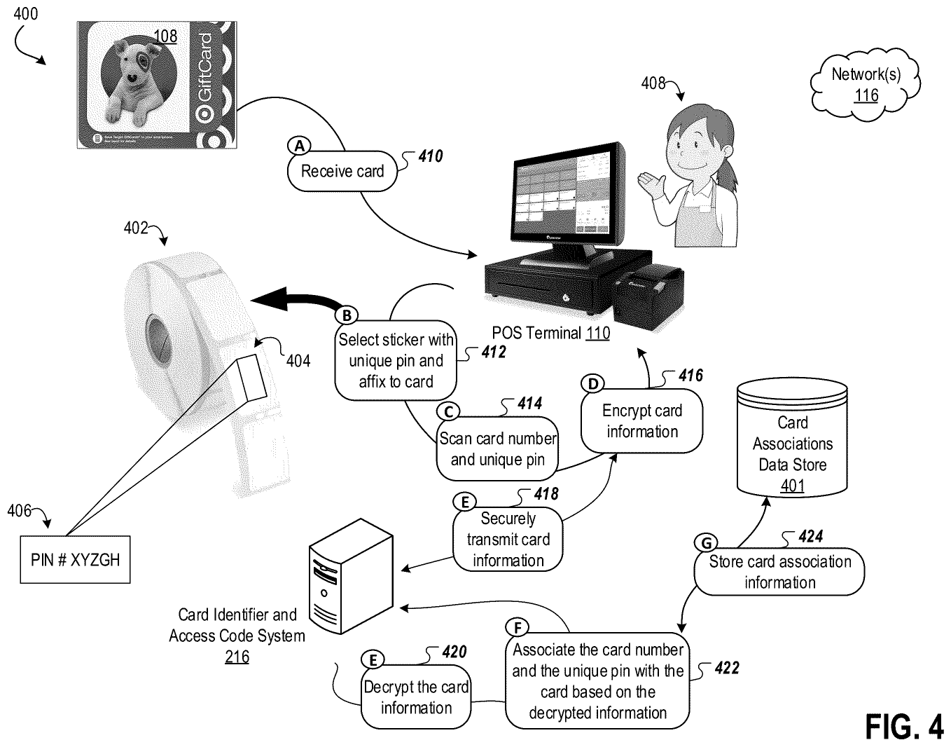

FIG. 4 is a conceptual diagram of a system 400 for purchasing and activating the physical gift card 108 with a sticker 404 having a PIN 406. Instead of using the printer 114 described herein to print/apply a PIN and/or card number onto the physical card 108, the PIN 406 can be determined and/or predetermined, then printed onto the sticker 404, which can then be affixed to the card 108 at a time of purchase. The sticker 404 can be part of a roll of stickers 402, where each of a plurality of stickers on the roll 402 can have a randomly generated value as a respective PIN. The PIN 406 can then be logged in association with other identifying information for the card 108 using computing systems like the card identifier and access code system 216. In some implementations, the PIN 406 can be predetermined and then pre-printed on the sticker 404. Therefore, in the system 400, the sticker 404 may simply be selected from the roll 402, applied to the card 108, and the PIN 406 on the sticker 404 can be scanned and associated with the card 108. In some implementations, the PIN 406 can be determined on demand, in real-time using the disclosed techniques, then printed onto the sticker 404 at the time of purchase before applying the sticker 404 to the card 108.

An employee 408 or other relevant user can receive the gift card 108 at the POS terminal 110 (block A, 410). The employee 408 can then select the sticker 404 from the roll 402, which has the PIN 406 (block B, 412). The employee 408 can affix the selected sticker 404 to the card 108, such as on a back surface of the card 108. The employee 408 can select a next sticker on the roll 402. The employee 408 can randomly select any of the stickers on the roll 402.

The employee 408 can then scan a card number and/or barcode associated with the card 108 along with the PIN 406 of the sticker 404 that was affixed to the card 108 (block C, 414). The scanned card information can be encrypted at the POS terminal 110 using one or more of the encryption techniques described herein (block D, 416).

The encrypted card information can be securely transmitted to the card identifier and access code system 216 (block E, 418), where the system 216 can decrypt the card information (block E, 420). Refer to FIG. 2 for further discussion about encryption and decryption techniques.

The system 216 can then associate the card number and the PIN 406 with the card 108 based on processing the decrypted card information (block F, 422). The system 216 can also store the card association information in a card associations data store 401 (block G, 424). Associating the information can include checking against information already stored in the data store 401 to determine whether the PIN 406 has already been assigned to another gift card. Associating the information can also include checking against information already stored in the data store 401 to determine whether the particular card 108 has already been assigned another PIN or otherwise is activated.

In some implementations, the system 216 may make associations between the card 108 and a particular POS terminal, cash register, and/or employee that rang up the card 108 during the checkout process. Any of the associations described herein can be determined by the system 216 using one or more techniques and/or one or more criteria for determining the associations. The system 216 can store information such as a retail environment identifier, a POS terminal/register identifier, a date, and time in a data store in association with the card 108. One or more other information may be generated, logged, and/or stored in association with the card 108.

The system 216 can determine an amount of time since the card 108 was printed and/or shipped as an indicator of compromise. As an illustrative example, if first, second, and third cards are printed on January 1, and the second and third cards show up at a retail environment on January 15, but the first card does not show up until March 1, the system 216 may determine that the first card was compromised. One or more other rules and/or criteria may be used to determine a likelihood that one of the cards was compromised. The system 216 can also generate one or more recommended actions in response to determining that the first card was compromised. The recommended actions can include destroying the first card.

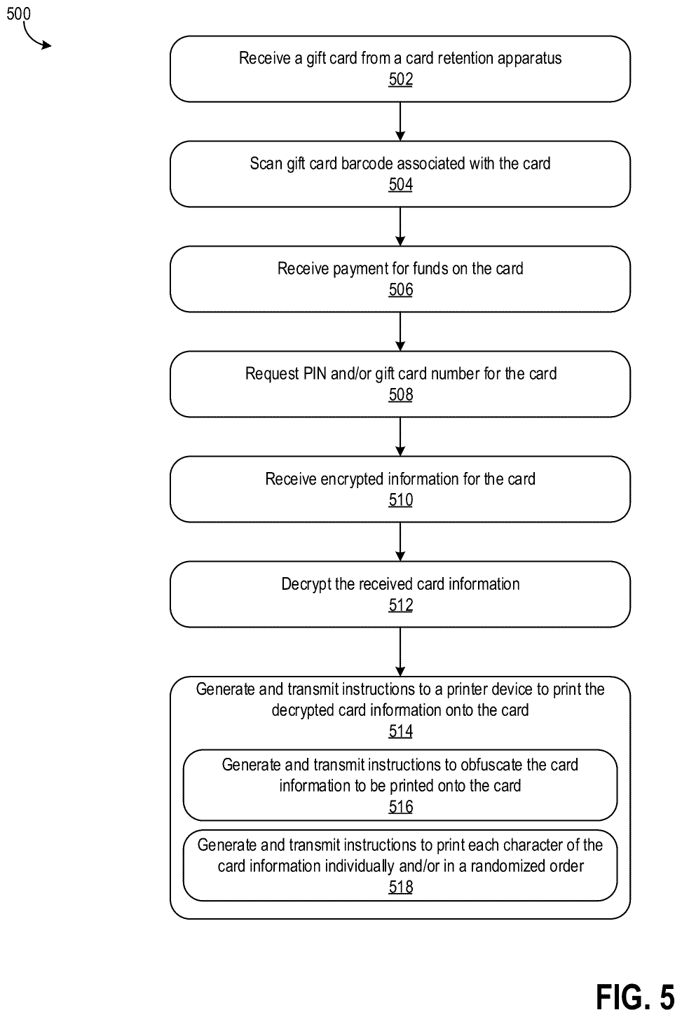

FIG. 5 is a flowchart of a process 500 for assigning and activating a physical gift card with unique identifying card information at a time of purchase during checkout. The process 500 can be performed to ensure that unique identifying information for a gift card is not exposed until the card is purchased and paid for during the checkout process. The process 500 can be performed by one or more system components described herein, such as the POS terminal 110, the card identifier and access code system 216, the card printing device 114, the card redemption system 214, and/or the fraud detection system 112. One or more blocks in the process 500 may be performed by relevant users, such as a worker or other employee at a POS terminal or checkout lane in a retail environment. The process 500 can also be performed by one or more other computing systems, devices, computers, networks, cloud-based systems, and/or cloud-based services. For illustrative purposes, the process 500 is described from the perspective of a computer system.

Referring to the process 500, the computer system can receive a gift card from a card retention apparatus in block 502. Refer to at least blocks A and B (120, 122) in FIG. 1 and block A (220) in FIG. 2 for further discussion.

In block 504, a barcode (e.g., SKU) of the gift card can be scanned. Refer to at least block C (124) in FIG. 1 and block B (221) in FIG. 2 for further discussion.

The computer system can receive payment for funds to be added to the card in block 506. For example, a user (e.g., customer, guest) purchasing the card can designate at the POS terminal how much money they would like to put onto the card. The user can select the amount of money from a list of various dollar amounts (or other currencies). The user can manually input the amount of money desired using a key pad, touchscreen, or other type of input device at the POS terminal. The user can also tell an employee at the POS terminal the amount of money to add to the card, and then the employee can apply the user-designated amount to the card. The user then may provide payment, such as a credit card, mobile wallet, cash, etc., at the POS terminal to apply the amount of money (e.g., funds) to the card. Once the payment is received and processed, the computer system can verify the purchase of the gift card and proceed to apply the funds to the card. Refer to at least block C and block D (124, 126) in FIG. 1 and block B (221) in FIG. 2 for further discussion.

The computer system can request a PIN and/or gift card number for the card (block 508). Sometimes, the computer system can encrypt the request, then transmit the request to a system such as the card identifier and access code system 216. The request can include, for example, an encryption key used for encrypting and/or decrypting information associated with the scanned gift card. Refer to at least block C (222) in FIG. 2.

In block 510, the computer system can receive encrypted information for the card. The encrypted information can be received from the card identifier and access code system 216. The system 216 can be configured to use the encryption key to access information (e.g., stored in a data store or other type of data repository) that has been associated with the gift card, such as the PIN and/or gift card number. This PIN and/or gift card number may be used to provide access to the funds that have been added to the card during the checkout process. The encryption key can also be used by the system 216 to encrypt the accessed information for the gift card before transmitting such information to the computer system. Refer to FIG. 2 for further discussion about encryption and decryption techniques. In some implementations, the gift card may not already be associated with unique information, such as the PIN and/or gift card number. Rather, the computer system, or another system receiving the request from block 508, can generate the unique information in response to receiving the request. The unique information can be randomly generated. The unique information can also be generated using one or more machine learning techniques, rulesets, and/or algorithms. For example, the computer system may integrate date of printing, intended recipient retail environment/region, location/vendor that printed the card, version of number generation algorithm, and/or serial number as information/inputs for generating the new PIN and/or card number for the gift card. In some implementations, the computer system can generate the PIN as a one-way hash of a serial number for the gift card. In other words, the PIN can be validated against the serial number, but the PIN may not be generated from the serial number, which may be similar to abbreviated checksum techniques. Refer to at least block E (128) in FIG. 1 and blocks D and E (224, 226) in FIG. 2 for further discussion.

Accordingly, the computer system can decrypt the received card information (block 512). The computer system can decrypt the information using a private key or other encryption key that is known to the computer system and securely stored there. Refer to at least blocks F and G (228, 230) in FIG. 2 for further discussion.

The computer system can generate and transmit instructions to a printer device to print/apply the decrypted card information onto the physical gift card (block 514). For example, the computer system can generate and transmit instructions to obfuscate the card information to be printed onto a surface of the card (block 516). As another example, the computer system can generate and transmit instructions to print each character of the card information (or a portion thereof) individually and/or in a randomized order onto the surface of the card (block 518). Any of blocks 514, 516, and 518 may also include encrypting information in the instructions and/or encrypting the instructions altogether using the encryption key. Refer to FIGS. 3A, 3B, 3C, 3D, and 3E for further discussion about exemplary printing instructions.

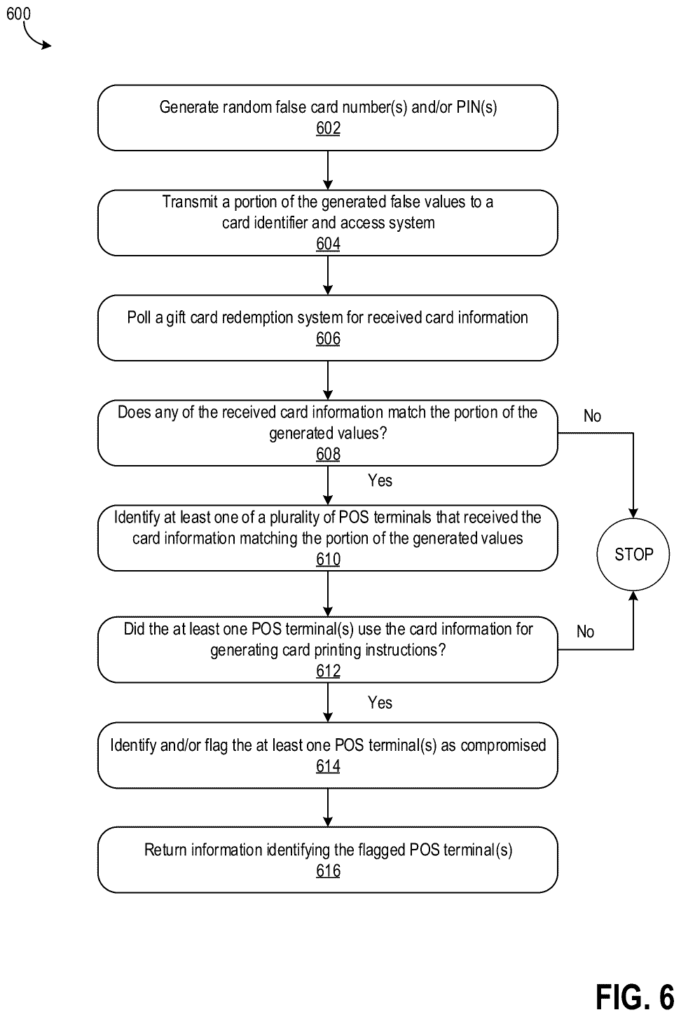

FIG. 6 is a flowchart of a process 600 for determining whether a checkout device has been compromised during purchase and/or activation of a physical gift card using the checkout device. The process 600 and similar cryptographic security techniques may be performed over an unencrypted channel on a compromised POS terminal. In some implementations, the gift cards may include active NFC and/or EMV chips to handle cryptographic handshakes.

The process 600 can be performed by the fraud detection system 112 described herein. Sometimes, one or more system components described herein, such as the POS terminal 110, the card identifier and access code system 216, the card printing device 114, and/or the card redemption system 214 may perform one or more blocks in the process 600. The process 600 can also be performed by one or more other computing systems, devices, computers, networks, cloud-based systems, and/or cloud-based services. For illustrative purposes, the process 600 is described from the perspective of a computer system.

Referring to the process 600, the computer system can generate false card numbers and/or PINs in block 602. This false card information can be generated using random number generators, rules, algorithms, and/or AI techniques. The false card information may not be associated with gift cards available for purchase or that have been purchased and/or activated/used at a retail environment.

The computer system can transmit a portion of the generated false values to a card identifier and access system, such as the system 216 described in reference to FIG. 2 (block 604). The card identifier and access system can store/maintain the portion of the generated false values. Then, when a gift card purchase is made at a POS terminal in the retail environment, the card identifier and access system may be polled by the POS terminal for identifying information associated with the gift card, and the system can return the generated false values as part of the testing performed in the process 600. In some implementations, the system can also return actual identifying information that was generated and/or associated with the purchased gift card. In yet some implementations, the system can provide the generated false values to the POS terminal randomly and/or at predetermined time intervals, regardless of whether the POS terminal is in fact performing and completing a transaction to purchase a gift card.

In block 606, the computer system can poll a gift card redemption system for received card information. The gift card redemption system can track card information that is received by one or more backend computing systems of online retail environments. The gift card redemption system can track card information that is received at a plurality of POS terminals in the retail environment. The plurality of POS terminals can provide the received card information to the redemption system randomly and/or at predetermined time intervals (e.g., every 1 hour, every 12 hours, every day, every 3 days, etc.). In some implementations, the computer system may also generate instructions for the gift card redemption system to poll particular POS terminals for received card information in block 606. For example, the redemption system can receive instructions from the computer system to poll a different group of POS terminals during each iteration/performance of the process 600. The computer system can determine that the redemption system should poll a group of POS terminals that have been previously identified as potentially being compromised. The computer system can determine that the redemption system should poll a group of POS terminals that have not been previously identified as potentially being compromised.

A polled POS terminal can return information/data indicating whether and/or what card information it has received during a period of time identified by the polling computer system (e.g., a past 1 hour, a past 1 day, a past 30 minutes, a past 5 minutes). The returned information/data can include, for example, the card information that was received at the polled POS terminal. Similarly, the backend system can return information indicating whether and/or what card information it received during a period of time identified by the polling computer system. The returned information can be associated with online purchases that are made and/or attempted in the online retail environment.

The computer system can then determine whether any of the received card information match the portion of the generated false values (block 608). The computer system can apply rules, for example, to compare the received card information to the portion of the generated false values to determine whether any match.

If none of the received information matches the portion of the generated values, the computer system can stop the process 600. The computer system may also return to block 602 and iterate through the process 600 continuously and/or at predetermined time intervals (e.g., every 5 minutes, every 10 minutes, every 30 minutes, every 1 hour, every 10 hours, every day, every other day, etc.). This indicates that gift card fraud likely has not occurred or been detected in the retail environment (either online or physical).

If any of the received information matches the portion of the generated values in block 608, the computer system can identify at least one of the plurality of POS terminals that received the card information matching the portion of the generated values (block 610). The computer system then proceeds to either block 612 or block 614. In some implementations, if the received information matches the portion of the generated values and the information was received from the backend system, the computer system can determine that potential gift card fraud has occurred during an online purchase in the online retail environment. The computer system may then stop the process 600. The computer system can also generate a record for storage in a data store that associates the identified potential gift card fraud with the particular online purchase/transaction.

The computer system can optionally determine whether the at least one POS terminal(s) used the card information for generating card printing/application instructions in block 612. The computer system may poll the at least one POS terminal(s) for transaction information and/or other information indicating actions performed at the POS terminal since receiving the card information. The POS terminal(s) can return such transaction information to the computer system, which can indicate whether the POS terminal used the card information to generate the card printing instructions. Sometimes, the returned transaction information can include print instructions generated by the POS terminal(s).

If the at least one POS terminal(s) did not use the card information to generate the print instructions, then the computer system can stop the process 600 or iterate back through the process by returning to at least block 602. In some implementations, if multiple POS terminals were identified in block 610, the computer system can iterate through block 612 for each of the identified multiple POS terminals.

If the at least one POS terminal(s) did use the card information to generate the print instructions in block 612, the computer system can identify and/or flag the at least one POS terminal(s) as compromised (or potentially compromised) in block 614.

The computer system can return information identifying the flagged POS terminal(s) in block 616. The returned information can include a unique identifier associated with the POS terminal(s). Returning the information can include adding the flagged POS terminal(s) to a watch list, so that actions performed at that POS terminal can be monitored for potential additional compromises.

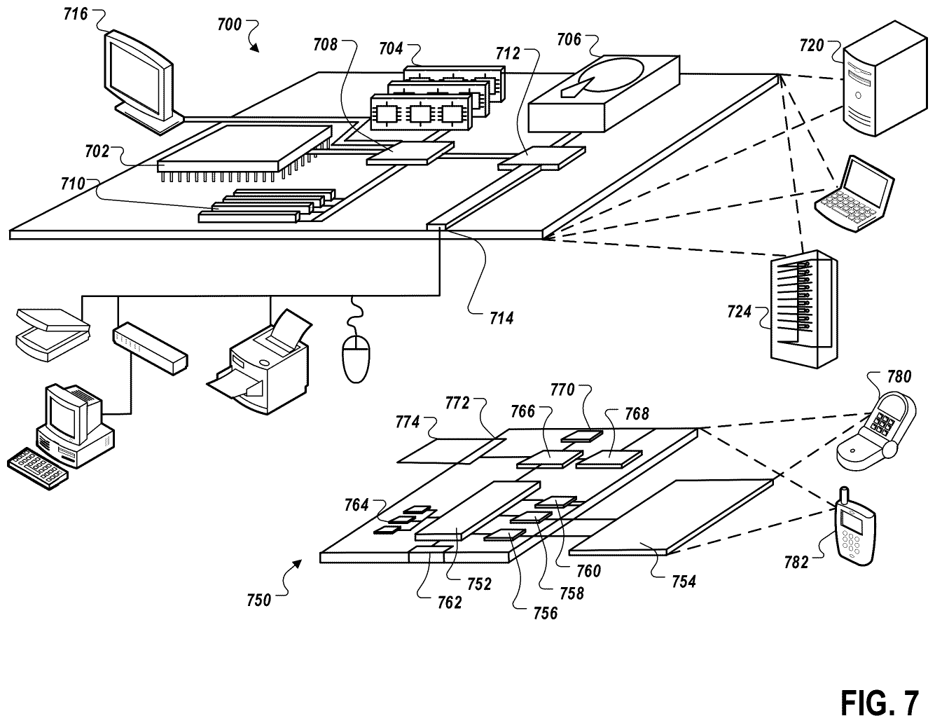

FIG. 7 shows an example of a computing device 700 and an example of a mobile computing device that can be used to implement the techniques described here. The computing device 700 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this disclosure.

The computing device 700 includes a processor 702, a memory 704, a storage device 706, a high-speed interface 708 connecting to the memory 704 and multiple high-speed expansion ports 710, and a low-speed interface 712 connecting to a low-speed expansion port 714 and the storage device 706. Each of the processor 702, the memory 704, the storage device 706, the high-speed interface 708, the high-speed expansion ports 710, and the low-speed interface 712, are interconnected using various busses, and can be mounted on a common motherboard or in other manners as appropriate. The processor 702 can process instructions for execution within the computing device 700, including instructions stored in the memory 704 or on the storage device 706 to display graphical information for a GUI on an external input/output device, such as a display 716 coupled to the high-speed interface 708. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 704 stores information within the computing device 700. In some implementations, the memory 704 is a volatile memory unit or units. In some implementations, the memory 704 is a non-volatile memory unit or units. The memory 704 can also be another form of computer-readable medium, such as a magnetic or optical disk.

The storage device 706 is capable of providing mass storage for the computing device 700. In some implementations, the storage device 706 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 704, the storage device 706, or memory on the processor 702.

The high-speed interface 708 manages bandwidth-intensive operations for the computing device 700, while the low-speed interface 712 manages lower bandwidth-intensive operations. Such allocation of functions is exemplary only. In some implementations, the high-speed interface 708 is coupled to the memory 704, the display 716 (e.g., through a graphics processor or accelerator), and to the high-speed expansion ports 710, which can accept various expansion cards (not shown). In the implementation, the low-speed interface 712 is coupled to the storage device 706 and the low-speed expansion port 714. The low-speed expansion port 714, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 700 can be implemented in a number of different forms, as shown in the figure. For example, it can be implemented as a standard server 720, or multiple times in a group of such servers. In addition, it can be implemented in a personal computer such as a laptop computer 722. It can also be implemented as part of a rack server system 724. Alternatively, components from the computing device 700 can be combined with other components in a mobile device (not shown), such as a mobile computing device 750. Each of such devices can contain one or more of the computing device 700 and the mobile computing device 750, and an entire system can be made up of multiple computing devices communicating with each other.

The mobile computing device 750 includes a processor 752, a memory 764, an input/output device such as a display 754, a communication interface 766, and a transceiver 768, among other components. The mobile computing device 750 can also be provided with a storage device, such as a micro-drive or other device, to provide additional storage. Each of the processor 752, the memory 764, the display 754, the communication interface 766, and the transceiver 768, are interconnected using various buses, and several of the components can be mounted on a common motherboard or in other manners as appropriate.

The processor 752 can execute instructions within the mobile computing device 750, including instructions stored in the memory 764. The processor 752 can be implemented as a chipset of chips that include separate and multiple analog and digital processors. The processor 752 can provide, for example, for coordination of the other components of the mobile computing device 750, such as control of user interfaces, applications run by the mobile computing device 750, and wireless communication by the mobile computing device 750.

The processor 752 can communicate with a user through a control interface 758 and a display interface 756 coupled to the display 754. The display 754 can be, for example, a TFT (Thin-Film-Transistor Liquid Crystal Display) display or an OLED (Organic Light Emitting Diode) display, or other appropriate display technology. The display interface 756 can comprise appropriate circuitry for driving the display 754 to present graphical and other information to a user. The control interface 758 can receive commands from a user and convert them for submission to the processor 752. In addition, an external interface 762 can provide communication with the processor 752, so as to enable near area communication of the mobile computing device 750 with other devices. The external interface 762 can provide, for example, for wired communication in some implementations, or for wireless communication in other implementations, and multiple interfaces can also be used.

The memory 764 stores information within the mobile computing device 750. The memory 764 can be implemented as one or more of a computer-readable medium or media, a volatile memory unit or units, or a non-volatile memory unit or units. An expansion memory 774 can also be provided and connected to the mobile computing device 750 through an expansion interface 772, which can include, for example, a SIMM (Single In Line Memory Module) card interface. The expansion memory 774 can provide extra storage space for the mobile computing device 750, or can also store applications or other information for the mobile computing device 750. Specifically, the expansion memory 774 can include instructions to carry out or supplement the processes described above, and can include secure information also. Thus, for example, the expansion memory 774 can be provide as a security module for the mobile computing device 750, and can be programmed with instructions that permit secure use of the mobile computing device 750. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 764, the expansion memory 774, or memory on the processor 752. In some implementations, the computer program product can be received in a propagated signal, for example, over the transceiver 768 or the external interface 762.

The mobile computing device 750 can communicate wirelessly through the communication interface 766, which can include digital signal processing circuitry where necessary. The communication interface 766 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 768 using a radio-frequency. In addition, short-range communication can occur, such as using a Bluetooth, WiFi, or other such transceiver (not shown). In addition, a GPS (Global Positioning System) receiver module 770 can provide additional navigation- and location-related wireless data to the mobile computing device 750, which can be used as appropriate by applications running on the mobile computing device 750.

The mobile computing device 750 can also communicate audibly using an audio codec 760, which can receive spoken information from a user and convert it to usable digital information. The audio codec 760 can likewise generate audible sound for a user, such as through a speaker, e.g., in a handset of the mobile computing device 750. Such sound can include sound from voice telephone calls, can include recorded sound (e.g., voice messages, music files, etc.) and can also include sound generated by applications operating on the mobile computing device 750.

The mobile computing device 750 can be implemented in a number of different forms, as shown in the figure. For example, it can be implemented as a cellular telephone 780. It can also be implemented as part of a smart-phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A system for performing a gift card purchase and activation in a retail environment, the system comprising:
a card retention apparatus comprising a unidirectional card removal component and a gift card, wherein the gift card is removable from the card retention apparatus using the unidirectional card removal component;
a point of sale (POS) terminal configured to process a purchase and activation of the gift card that is removed from the card retention apparatus;
a card identifier and access code system in network communication with the POS terminal and configured to generate and assign unique identifying information to the gift card in response to the purchase and activation of the gift card at the POS terminal; and
a printing device in network communication with the POS terminal and configured to execute instructions received from the POS terminal to print at least a portion of the unique identifying information onto a surface of the gift card,
wherein the POS terminal is configured to perform operations comprising:
scanning, using a scanning device of the POS terminal, a barcode of the gift card to identify the gift card;
transmitting, to the card identifier and access code system, a request for the unique identifying information for the gift card, wherein the request includes a public encryption key associated with the identified gift card;
receiving, from the card identifier and access code system and in response to the card identifier and access code system (i) generating the unique identifying information for the gift card and (ii) encrypting the unique identifying information using the public key, the encrypted unique identifying information for the gift card;
decrypting, using a private key associated with the identified gift card, the encrypted unique identifying information;
generating instructions for applying the at least portion of the unique identifying information onto the surface of the gift card; and
returning, to the printing device, the instructions for execution.

2. The system of claim 1, wherein the printing device is configured to receive the gift card.

3. The system of claim 1, wherein, in response to receiving payment, at the POS terminal, for the purchase and activation of the gift card, the POS terminal is configured to perform the operation comprising transmitting, to the card identifier and access code system, a request for the unique identifying information for the gift card.

4. The system of claim 1, wherein the unique identifying information is a card number associated with the identified gift card.

5. The system of claim 1, wherein the unique identifying information is a PIN associated with the identified gift card.

6. The system of claim 1, wherein the unique identifying information comprises a card number and a PIN associated with the identified gift card.

7. The system of claim 1, wherein the POS terminal comprises an encryption mechanism, the encryption mechanism being configured to maintain the public key and the private key associated with the gift card.

8. The system of claim 1, wherein the instructions comprise applying the unique identifying information onto a back surface of the gift card.

9. The system of claim 1, wherein the instructions comprise a plurality of application steps, wherein each of the plurality of application steps comprises applying a subset of values in the unique identifying information onto the surface of the gift card.

10. The system of claim 1, wherein the instructions comprise (i) applying at least one false card identifying information onto a test document and (ii) applying the unique identifying information onto the surface of the gift card.

11. The system of claim 1, wherein the instructions comprise applying each character of the unique identifying information individually.

12. The system of claim 1, wherein the instructions comprise applying each character of the unique identifying information in a randomized order.

13. A method for performing a gift card purchase and activation in a retail environment, the method comprising:
identifying, by a POS terminal in the retail environment, a gift card for purchase and activation;
receiving, by the POS terminal, a payment for the purchase and activation of the identified gift card;
transmitting, by the POS terminal to a card identifier and access code system, a request for unique identifying information for the gift card in response to processing the payment, wherein the request includes a public encryption key associated with the identified gift card;
receiving, by the POS terminal from the card identifier and access code system and in response to the card identifier and access code system (i) generating the unique identifying information for the gift card and (ii) encrypting the unique identifying information using the public key, the encrypted unique identifying information for the gift card;
decrypting, by the POS terminal using a private key associated with the identified gift card, the encrypted unique identifying information;
generating, by the POS terminal, instructions for applying the at least portion of the unique identifying information onto a surface of the gift card; and
returning, by the POS terminal to a printing device, the instructions for execution.

14. The method of claim 13, wherein identifying a gift card for purchase and activation comprises scanning, using a scanning device of the POS terminal, a barcode or SKU of the gift card.

15. An apparatus for retaining a physical gift card to a physical display in a retail environment, the apparatus comprising:
a unidirectional card removal component comprising perforations; and
a gift card removably attached to the unidirectional card removal component along the perforations, wherein the gift card is removable in one direction by detaching the gift card from the unidirectional card removal component along the perforations.

16. The apparatus of claim 15, the apparatus further comprising unique identifying information associated with the gift card being applied onto a surface of the unidirectional card removal component.

17. The apparatus of claim 16, wherein the unique identifying information comprises a card number associated with the gift card.

18. The apparatus of claim 16, wherein the unique identifying information is further applied onto a surface of the gift card.

19. The apparatus of claim 15, wherein the gift card comprises preprinted paper.

20. The apparatus of claim 15, wherein the gift card comprises a generic barcode or SKU applied to a surface of the gift card at a time of manufacturing the unidirectional card removal component and the gift card attached thereto.
